(19) United States
(12) Patent Application Publication
(10) Pub. No.: US 2023/0089710 A1
(43) Pub. Date: Mar. 23, 2023

(54) DATA REQUEST SERVER CODE AND CONFIGURATION FILE DEPLOYMENT

(71) Applicant: Target Brands, Inc., Minneapolis, MN (US)

(72) Inventors: Timothy R. Schoenheider, Bloomington, MN (US); Ron Cuirle, Minneapolis, MN (US); Sean C. Ryan, Minneapolis, MN (US); Soumen Choudhury, Eden Prairie, MN (US)

(21) Appl. No.: 17/481,817

(22) Filed: Sep. 22, 2021

(51) Int. Cl. G06F 16/14; G06F 16/172; H04L 29/08

(52) U.S. Cl. CPC G06F 16/148; G06F 16/172; H04L 67/34; H04L 67/2842

(57) ABSTRACT

A server includes a network interface for connecting to a computer network and a processor configured to receive a query for data, use a configuration file to identify a data source on the computer network for resolving the query and return the data requested in the query. The processor also determines that the configuration file has been modified, retrieves a modified configuration file from the computer network, receives a second query for data, and uses the modified configuration file to identify a data source on the computer network for resolving the second query.

### BACKGROUND

Query languages are available that allow applications to submit query requests in hierarchical structures and receive data results in the same hierarchical structures. In some systems, a server is provided that receives the data query, identifies one or more data sources for the requested data, obtains the requested data from the data sources, and structures a response based on the structure of the request.

The discussion above is merely provided for general background information and is not intended to be used as an aid in determining the scope of the claimed subject matter. The claimed subject matter is not limited to implementations that solve any or all disadvantages noted in the background.

### SUMMARY

A computer-implemented method includes a processor retrieving a configuration file, loading a data definition from the configuration file, receiving from a requestor a request for data at an endpoint exposed by the processor, using the loaded data definition to obtain the requested data from a data source, and returning the requested data to the requestor. The processor then determines that the configuration file has been modified and in response to the configuration file being modified, the processor retrieves the modified configuration file, loads a modified data definition from the modified configuration file, receives from a second requestor a second request for data at the endpoint exposed by the processor, uses the loaded modified data definition to obtain the requested data from the data source, and returns the requested data to the second requestor.

In accordance with a further embodiment, a server includes a network interface for connecting to a computer network and a processor configured to receive a query for data, use a configuration file to identify a data source on the computer network for resolving the query and return the data requested in the query. The processor also determines that the configuration file has been modified, retrieves a modified configuration file from the computer network, receives a second query for data, and uses the modified configuration file to identify a data source on the computer network for resolving the second query.

In accordance with a further embodiment, a method includes retrieving a configuration file, providing an endpoint to receive data queries and utilizing the configuration file to process the data queries. The configuration file is monitored to determine if it has been modified. When the configuration file is determined to have been modified to produce a new configuration file, the new configuration file is used to process data queries.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is flow diagram of a method of deploying data request server code and configuration files.

FIG. 2 is a block diagram of a deployment system for deploying and executing data request server code and configuration files.

FIGS. 3A and 3B provide an example of a configuration file that extends across the two figures.

FIG. 4 is a flow diagram of a method of processing queries.

FIG. 5 is an example of a query.

FIG. 6 is an example of a response to a query.

FIG. 7 is a flow diagram of a configuration file monitor.

FIG. 8 is a block diagram of a computing device.

### DETAILED DESCRIPTION

Data request servers, such as GraphQL servers, execute server code that has been specifically written to convert queries for data received from clients into requests designed to obtain the data from one or more data sources. Because each server is designed to work with a different set of data sources, prior systems utilized custom server code for each data request server. Such code is inefficient to write initially and time consuming to maintain since each server's code must be maintained separately.

In the embodiments described below, an improved architecture is provided in which universal server code is provide that can be used by a plurality of different data request servers, such as GraphQL servers, that each support different collections of data sources. The universal code is adapted on each server to work with a particular group of data sources through a configuration file assigned to the server. To allow for the universal code to be deployed separately from the configuration file, the configuration file is stored in a separate software package from the server code on a continuous integration/continuous deployment system.

When the universal code begins executing on the server, the code requests the configuration file designated for the server's data sources and uses the configuration file to set the allowable data types and the information used to resolve queries received from clients. Using the system, individualized data request servers are achieved while allowing a majority of the data request server source code to be universal to all the servers so as to be more easily written and maintained. In addition, deploying the configuration file separately from the data request server code allows the configuration file to be modified frequently and easily without having to wait for redeployment of the data request server code. Thus, the server for one group of data sources can be updated by updating its configuration file without impacting the operation of other data request servers operating in accordance with other configuration files. This improves the operation of all of the data request servers because it requires fewer interruptions of their operation to install new data request server code. In addition, all servers run the same version of the data request server code making it easier to identify which servers need to be updated when a bug is found in the server code.

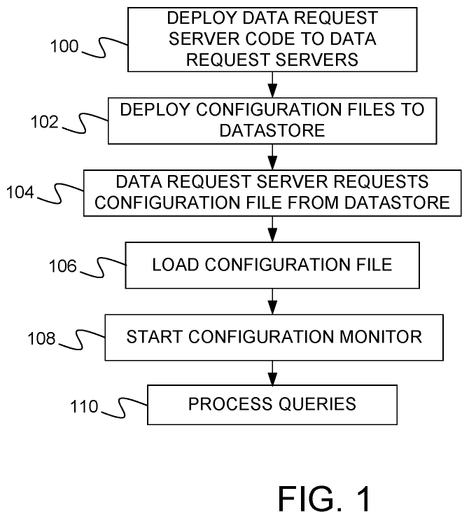

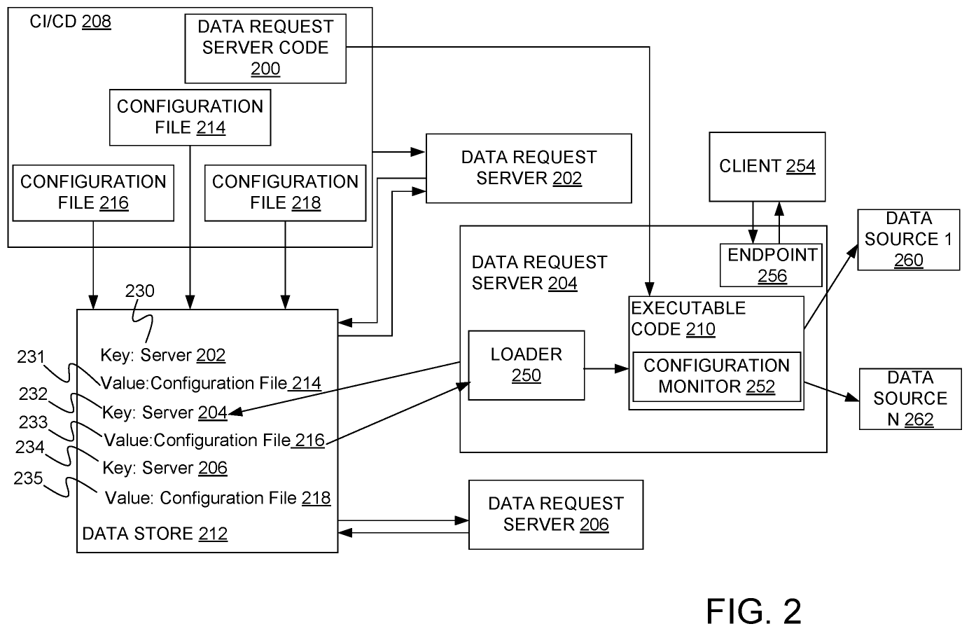

FIG. 1 provides a flow diagram of a method of deploying and using source code and configuration files to process data request queries. FIG. 2 provides a block diagram of a system for implementing the method of FIG. 1.

In step 100 of FIG. 1, data request server code 200 is deployed to one or more data request servers 202, 204 and 206 by a continuous integration/continuous deployment system (CI/CD) 208. CI/CD 208 allows programmers to create new versions of data request server code 200, to test those versions, and to designate a version for deployment. Deployment of data request server code 200 to each server results in executable code such as executable code 210 on server 204. Similar executable code is found on data request server 202 and data request server 206. In accordance with one embodiment, each data request server 202, 204 and 206 is associated with a different collection of data sources. As part of the deployment to each data request server, an associated key for the data request server is provided for accessing the configuration file associated with the data sources assigned to the data request server.

At step 102, a respective configuration file is deployed to a datastore 212 for each of the data request servers. In FIG. 2, configuration files 214, 216 and 218 corresponding to data request servers 202, 204 and 206, respectively, are each deployed separately in step 102. In accordance with one embodiment, configuration files 214, 216 and 218 are deployed using the CI/CD 208. Using CI/CD 208, each of configuration files 214, 216 and 218 may be modified separately and may be approved for deployment separately. Further, configuration files 214, 216 and 218 may be deployed without redeploying data request server code 200.

In accordance with one embodiment, datastore 212 stores each configuration file as part of a key/value pair where the key is used to access the value and the value is the configuration file. In FIG. 2, key 230 is associated with data request server 202, key 232 is associated with data request server 204 and key 234 is associated with data request 206. Value 231 associated with key 230 is configuration file 214, value 233, which is the value for key 232, is configuration file 216 and value 235, which is the value for key 234, is configuration file 218.

At step 104, each data request server requests its respective configuration file from datastore 212. In accordance with one embodiment, the data request servers receive their respective key for their respective configuration file and the location of datastore 212 as part of the deployment of data request server code 200.

At step 106, a configuration file loader, such as loader 250 in data request server 204, loads the information in the configuration file into executable code 210.

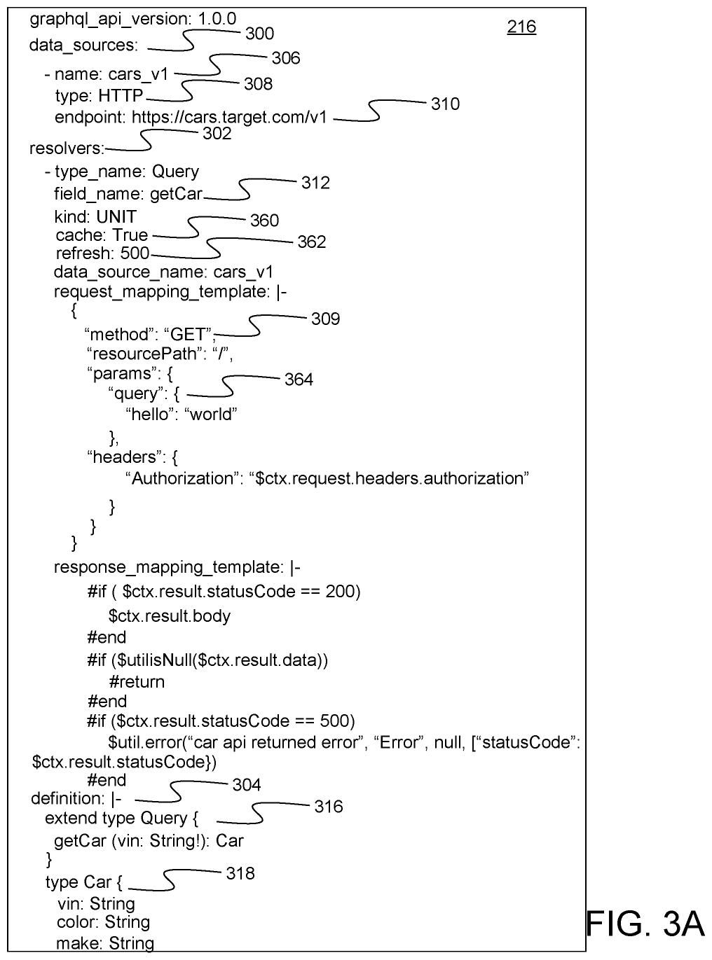

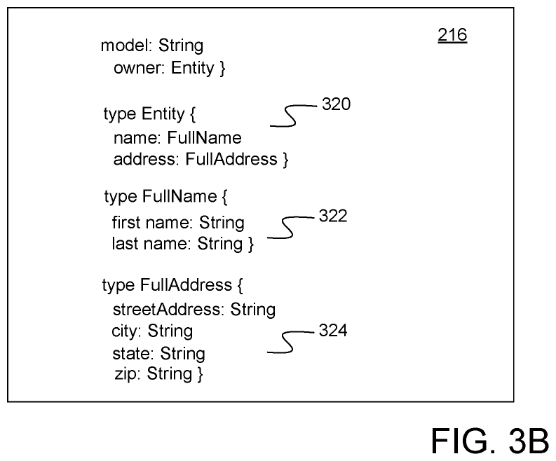

FIGS. 3A and 3B provide an example of configuration file 216 in accordance with one embodiment. In FIGS. 3A and 3B, configuration file 216 is shown to include a data sources section 300, a resolvers section 302 and a data definition section 304. Data sources section 300 provides information for one or more data source objects. In the example of FIG. 3A, a single data source is shown within data sources section 300 providing a name 306, a type of data source 308 and an endpoint for the data source 310. Endpoint 310 indicates the path where requests for data are to be sent for this data source.

Resolvers section 302 provides information for resolving data queries where resolving a data query involves matching the data query name to a field name in resolvers section 302, such as field name 312, and using the parameters stored for that field name to request the requested data from a data source, receive the returned data from the data source and structure the returned data to match the hierarchical structure of the query before returning the structured data to the requestor. In particular, a method 309 is used in combination with the path designated for endpoint 310 to identify how and where requests for data are to be sent for this data query.

Data definition section 304 includes definitions for various data types including a query data type that defines allowable structures for queries, such as query definition 316. Data definition section 304 includes additional type definitions for other objects such as definition 318 for a car object, definition 320 for an entity object, definition 322 for a full name object, and definition 324 for a full address object.

Loading step 106 of FIG. 1 involves deserializing the data source information in data sources section 300 to form data source objects, deserializing the resolver information in resolvers section 302 to form resolver objects, and using the type definitions in definition section 304 to generate a schema for validating and parsing queries.

After the configuration file has been loaded into executable code 210 at step 106, a configuration monitor 252 in executable code 210 is started at step 108. The operation of the configuration monitor is discussed further below.

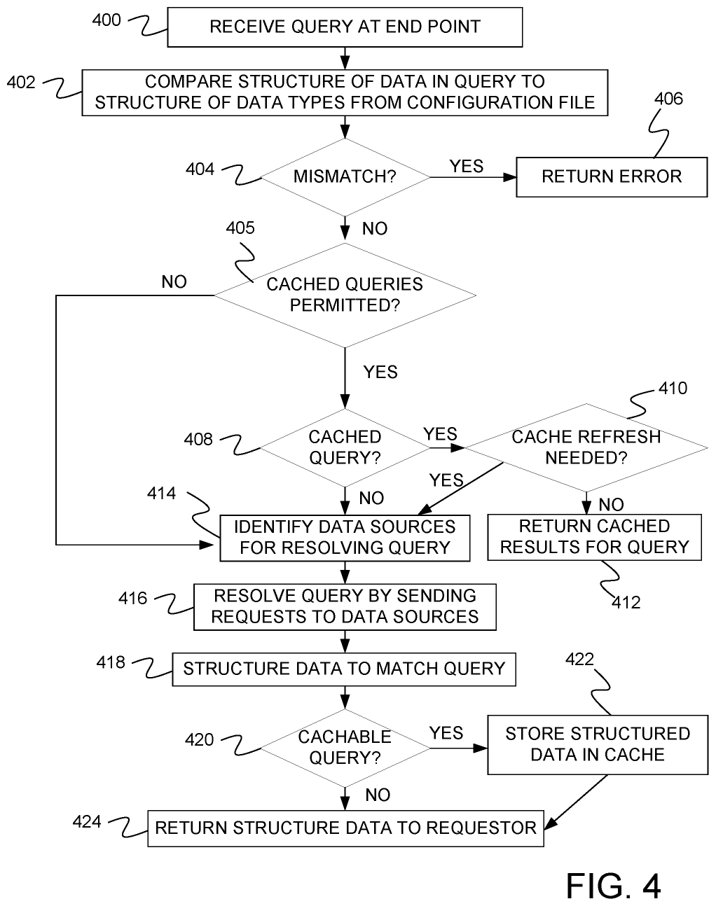

At step 110, executable code 210 begins to process queries from clients. FIG. 4 provides a flow diagram of a method of processing such queries.

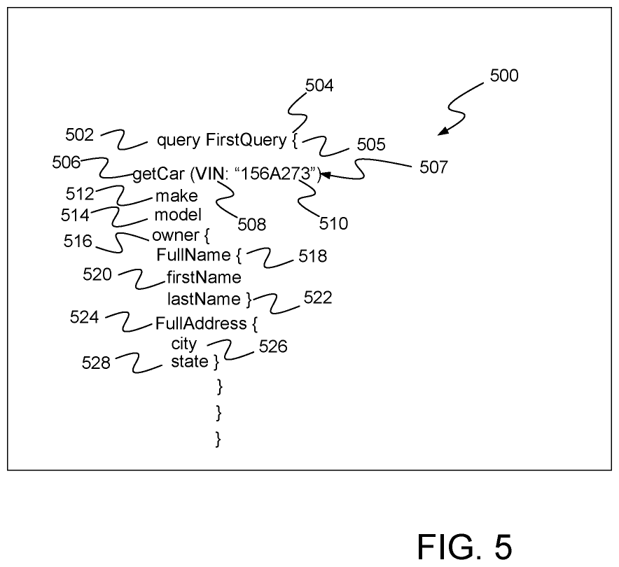

In step 400 of FIG. 4, a query is received from a client 254 at an end point 256 exposed by executable code 210. FIG. 5 provides an example query 500 that would be sent to the end point. Query 500 includes an operation type 502 set to “query”, an operation name 504 set to “first query”, and a selection set 505 designated by an opening bracket and an ending bracket and a collection of fields within those brackets. The fields within selection set 505 include include a top-level field 506 designated as “getCar”, three second level fields 512, 514 and 516 designated as “make”, “model” and “owner”. Within second level field 516, there are two third level fields 518 and 524 designated as “name” and “address”. Within third level field 518 there are two fourth level fields 520 and 522 designated as “first name”, and “last name”. Within third level field 524 there are two fourth level fields 526 and 528 designated as “city” and “state”. Thus, query 500 has a hierarchical structure in its selection set with the fourth level fields being within a third level field, the third level fields being within a second level field, and the second level fields being within a top-level field. In addition, in query 500, there is an argument 507 for top-level field 506 that designates a particular entity using field 508 designated as “VIN” and an identifier 510 set to “156A273”. Thus, query 500 is designed to retrieve information for a particular car identified by identifier 510 and that information is limited to the make, model, owner's first name, owner's last name, and owner's city and state.

At step 402 of FIG. 4, executable code 210 compares the structure of the data in the query to the structures of data types provided by the configuration file. If the structure of the data in the query does not match the structures of the data types in the configuration file at step 404, an error is returned at step 406. In comparing the data structures, not every field found in the data types defined in the configuration file needs to be present in the query. However, each data type found within the query must be defined in the data types of the configuration file and the fields found within another field must be defined within the type definition for that field. For example, the configuration file must define first name 520 and last name 522 as fields within a data type named “full name”.

If the structure of the query matches the structure of data types in the configuration file, executable code 210 determines if cached queries are permitted at step 405. Cached queries are queries that have their results stored on data request server 204 and do not require the data requested in the query to be retrieved from data sources, such as data sources 260 and 262 of FIG. 2 each time a query is received. Instead, the data for a cached query is retrieved from the data sources 260 and 262 when the first such query is received and is stored on data request server 204 to be provided in response to later queries for the same data. This makes data request server 204 more efficient since it does not have to request the data each time the same query is received. For some embodiments of executable code 210, cached queries are permitted and for other embodiments of executable code 210, cached queries are not permitted.

If cached queries are permitted, the top-level field name is compared to the field name in resolvers section 302 of the configuration file (see FIG. 3A) to determine if this query is a cached query at step 408. To determine if the current query is a cached query, the cache field, such as cache field 360 (see FIG. 3A) is examined for the top-level field name “getCar”. If cache field 360 is set to True, this is a cached query and if cached field 360 is set to False this is a not a cached query.

If the query is a cached query at step 408, executable code 210 then uses a refresh field 362 set for the top-level field name to determine if a cache refresh is needed. Refresh field 362 sets a time period for reacquiring the data from data sources 260 and 262. Executable code 210 compares the refresh field 362 to the period of time that has expired since the cached data was last received to determine if a cache refresh is needed. If a cache refresh is not needed, cached results from a previous query are returned for the query at step 412.

If cached queries are not permitted at step 405, or if a cache refresh is needed at step 410 or if this is not a cached query at step 408, executable code 210 identifies data sources for resolving the query at step 414 using the data source name field for the associated resolver and the properties of the associated data source from data sources section 300 of the configuration file. These properties include one or more endpoints, such as a RESTful API, for retrieving data, such as endpoint 310 of FIG. 3A.

At step 416, executable code 210 uses the data sources to resolve the query by sending requests to the data source endpoints. In accordance with one embodiment, these requests are constructed using a request mapping template, such as a request mapping template 364 provided by the configuration file. The requests are then passed to the endpoints of the data sources, such as data sources 260 and 262, which retrieve the data and return the data to executable code 210. At step 418, executable code 210 structures the returned data to match the structure provided in the query. Thus, the returned data is parsed to select only the fields requested in the query and to place the parsed data into a hierarchical structure that matches the hierarchical structure of the query.

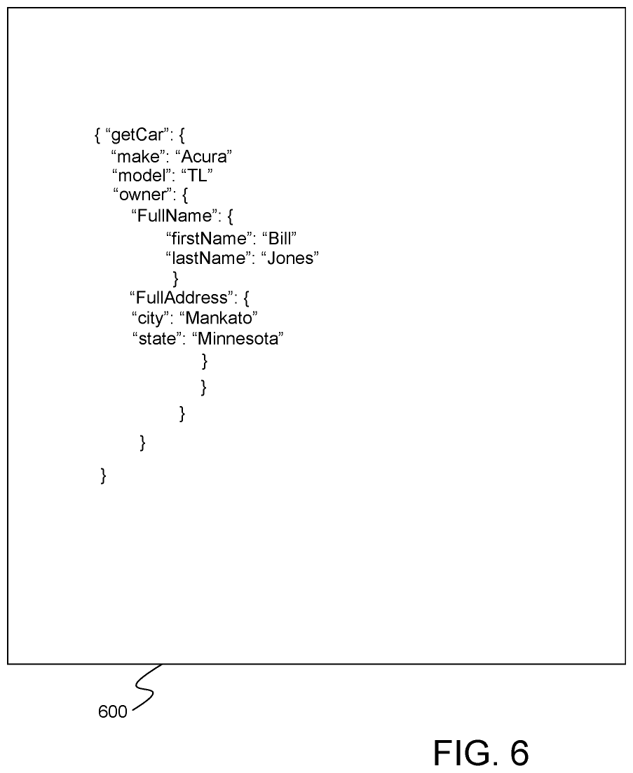

FIG. 6 provides an example of the parsed data after it has been placed in the hierarchical structure based on the query of FIG. 5. As shown in FIG. 6, the returned data has the same hierarchical structure as the query and contains all of the fields requested in the query and no additional fields.

At step 420, executable code 210 determines if this is a cacheable query. In order for a query to be cacheable, executable code 210 must permit query caching and this query must be designated as cacheable in the cache field of the configuration field. If this is a cacheable query, the structured data is stored at step 422 on data request server 204 so that it can be returned with the next request for this query. If this is not a cacheable query at step 420 or after step 422, the structure data is returned to client 254 at step 424.

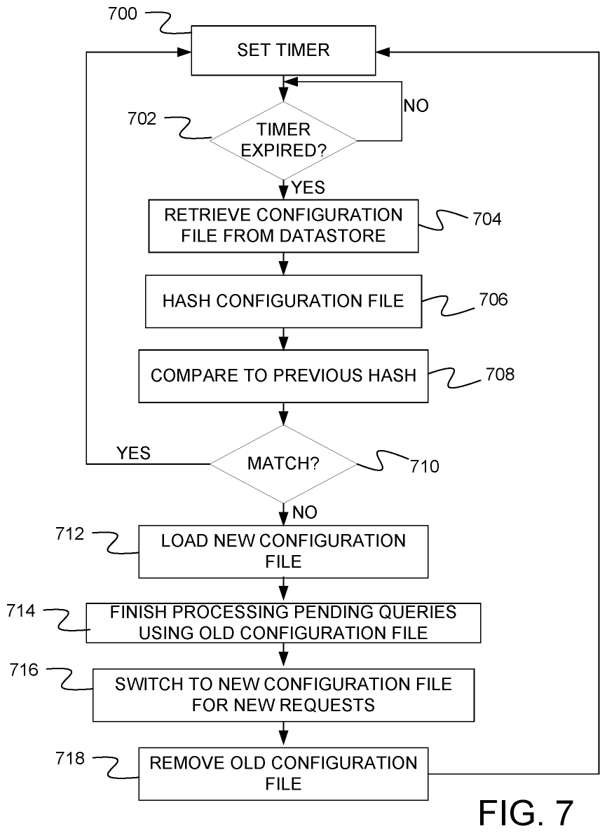

In step 108 of FIG. 1, a configuration monitor 252 was started when data request server code was deployed to data request server 204. FIG. 7 provides a flow diagram of a method used by the configuration monitor once it started.

In step 700 of FIG. 7, configuration monitor 252 sets a timer for checking on whether the configuration file stored in datastore 212 has been modified. At step 702, configuration monitor 252 determines if the timer has expired. If the timer has not expired, configuration monitor 252 waits. If the timer has expired, configuration monitor 252 retrieves the configuration file from datastore 212 at step 704. At step 706, configuration monitor 252 uses a hash function to hash the retrieved configuration file and at step 708 compares the resulting hash value to a previous hash value produced for the configuration file that is currently being used by data request server 204. In accordance with one embodiment, the hash function produces different hash values for configuration files that differ from each other in any way. If the two hash values match at step 710, the process returns to step 700 where the timer is reset and steps 702, 704, 706 and 708 are repeated. If the two hashes do not match at step 710, the data sources, resolvers and data types in the new configuration file are loaded into executable code 210 in place of the previous data sources, resolvers and data types at step 712. Changes to the configuration file can include one or more of adding data sources, removing data sources, changing parameters of data sources, adding resolvers, removing resolvers, changing parameters of resolvers such as whether the resolver caches its data, adding data types, removing data types and modifying data types, for example.

At step 714, executable code 210 finishes processing any pending queries using the data sources, resolvers and data types of the old configuration file. Thus, steps 700-714 are performed while executable code 210 continues to receive queries from clients, such as client 254, and while executable code 210 continues to resolve those queries to provide data to the requestors. Thus, the configuration file is monitored without impacting query processing. At step 716, executable code 210 switches to the data sources, type data and resolvers of the new configuration file, such as those shown in FIGS. 3A and 3B, to process new queries that are received by data request server 204. The data source, type data and resolvers of the old configuration file are then removed from the executable code at step 718. Configuration monitor 252 then returns to step 700 to repeat the steps of FIG. 7.

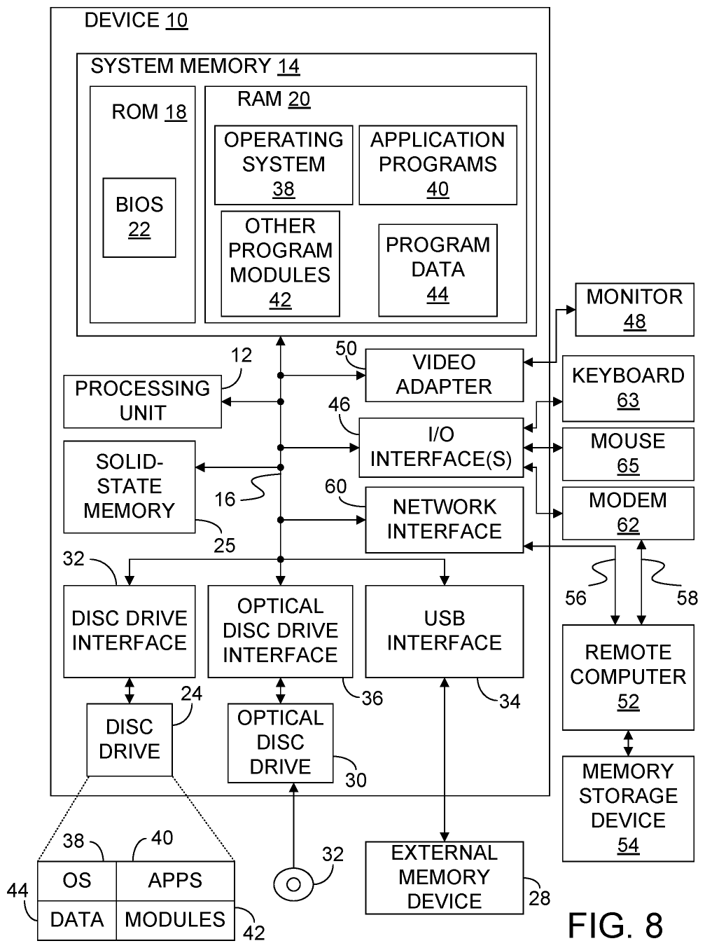

FIG. 8 provides an example of a computing device 10 that can be used to implement one or more of the servers discussed above. Computing device 10 includes a processing unit 12, a system memory 14 and a system bus 16 that couples the system memory 14 to the processing unit 12. System memory 14 includes read only memory (ROM) 18 and random-access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Computing device 10 further includes an optional hard disc drive 24, an optional external memory device 28, and an optional optical disc drive 30. External memory device 28 can include an external disc drive or solid-state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of the applications discussed above. Program data 44 may include any data used by the systems and methods discussed above.

Processing unit 12, also referred to as a processor, executes programs in system memory 14 and solid-state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 8. The network connections depicted in FIG. 8 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 8 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
a processor retrieving a configuration file, loading a data definition from the configuration file, receiving from a requestor a request for data at an endpoint exposed by the processor, using the loaded data definition to obtain the requested data from a data source, and returning the requested data to the requestor;
the processor determining that the configuration file has been modified;
in response to the configuration file being modified, the processor retrieving the modified configuration file, loading a modified data definition from the modified configuration file, receiving from a second requestor a second request for data at the endpoint exposed by the processor, using the loaded modified data definition to obtain the requested data from the data source, and returning the requested data to the second requestor.

2. The computer-implemented method of claim 1 wherein while determining that the configuration file has been modified, the processor is capable of using the loaded data definition to obtain data from the data source.

3. The computer-implemented method of claim 1 wherein while retrieving the modified configuration file, the processor is capable of using the loaded data definition to obtain data from the data source.

4. The computer-implemented method of claim 1 wherein the configuration file designates a query for caching by the processor.

5. The computer-implemented method of claim 4 wherein the modified configuration file designates the query as no longer requiring caching by the processor.

6. The computer-implemented method of claim 1 wherein the configuration file provides parameters for a query resolver.

7. The computer-implemented method of claim 1 wherein the configuration file provides a location of the data source.

8. A server comprising:
a network interface for connecting to a computer network;
a processor, configured to:
receive a query for data;
use a configuration file to identify a data source on the computer network for resolving the query;
return the data requested in the query;
determine that the configuration file has been modified;
retrieve a modified configuration file from the computer network,
receive a second query for data; and
use the modified configuration file to identify a data source on the computer network for resolving the second query.

9. The server of claim 8 wherein the processor further uses the modified configuration file to determine if the second query is a valid query.

10. The server of claim 9 wherein the processor determines if the second query is a valid query by comparing fields in the query to types defined in the modified configuration file.

11. The server of claim 8 wherein the processor identifies a RESTful API as the data source using the modified configuration file.

12. The server of claim 8 wherein the processor is configured to further use the modified configuration file to determine whether to cache data retrieved from the data source at the server.

13. The server of claim 12 wherein the processor is further configured to use the modified configuration file to determine a period of time during which the processor returns data cached at the server in response to data queries instead of requesting data from a data source in response to the data queries.

14. The server of claim 8 wherein while determining whether the configuration file has been modified, the processor:
receives a third query for data; and
uses the configuration file to identify a data source on the computer network for resolving the third query.

15. A method comprising:
retrieving a configuration file;
providing an endpoint to receive data queries and utilizing the configuration file to process the data queries;
monitoring the configuration file to determine if it has been modified;
when the configuration file is determined to have been modified to produce a new configuration file, utilizing the new configuration file to process data queries.

16. The method of claim 15 wherein utilizing the configuration file to process a data query comprises using a data source listed in the configuration file to retrieve data from.

17. The method of claim 16 wherein utilizing the configuration file to process a data query further comprises using data type definitions listed in the configuration file to validate the data query.

18. The method of claim 15 wherein utilizing the configuration file to process the data queries comprises using the configuration file to determine whether to return data cached at a server.

19. The method of claim 15 wherein monitoring the configuration file comprises periodically retrieving the configuration file and performing a comparison between a currently retrieved version of the configuration file and a previously retrieved version of the configuration file.

20. The method of claim 15 wherein monitoring the configuration file occurs while processing data queries.
